(19) United States
(12) Patent Application Publication
(10) Pub. No.: US 2002/0055886 A1
(43) Pub. Date: May 9, 2002

(54) System and method for maintaining and utilizing component cross reference data in an exchange system

(75) Inventor: Paul F. Hinckley, North Reading, MA (US)

Correspondence Address: PILLSBURY WINTHROP LLP, 1600 TYSONS BOULEVARD, MCLEAN, VA, 22102, US

(73) Assignee: Converge, Inc., Peabody, MA

(21) Appl. No.: 09/986,173

(22) Filed: Nov. 7, 2001

Related U.S. Application Data
(60) Provisional application No. 60/246,605, filed on Nov. 8, 2000.

(51) Int. Cl. G06F 17/60

(52) U.S. Cl. 705/26

(57) ABSTRACT

A system and method are provided that enable at least one of a user of a component exchange system and entities trading on that exchange to access a master cross reference list of components, including a list of inferred equivalent components, to guide component trading decisions.

The present application claims priority to U.S. provisional application of Hinckley, Ser. No. 60/246,605, filed Nov. 8, 2000, the entirety of which is hereby incorporated into the present application by reference.

### BACKGROUND OF THE INVENTION

1. Field of the Invention

The present invention relates to a method and system for use in a business to business marketplace and, more particularly, to a system and method enabling customers to utilize cross-referencing data during transactions relating to components associated with multiple manufacturers.

2. Description of Related Art

Manufacturers of devices (hereafter referred to as “device manufacturers” or “DMs”) routinely incorporate one or more commercially available components manufactured by other manufacturers. Thus, DMs routinely enter into business transactions with suppliers of components who may be Component Manufacturers (CMs), middle men or other DMs trying to sell excess inventory. The price and quantity of available components for sale is often dependent on the business relationships that a particular buyer has with one or more CSs. Thus, for example, if a Component Buyer (CB) has more relationships with various component suppliers, the buyer is more likely to obtain more available components at better prices.

However, in a large market place such as the one illustrated in FIG. 1, it is often difficult for a CB (which may be, for example, a DM), e.g., one of the CBs 122-128, to identify potential Component Sellers (CSs), such as the CSs 112-118, and build relationships with a large number of CSs. Similarly, in such a market place, it is difficult for a CS, e.g., 112-118, to identify potential CBs, e.g., 122-128, and build relationships with a large number of CBs. As a result, it is not uncommon that a CB, e.g., 126, with few relationships to CSs (in this illustration, with only one seller 114) having available components may have to pay higher prices for components. Similarly, it is not uncommon that a CS, e.g., seller 112, with few relationships to CBs (in this illustration, with only two buyers 122 and 124) looking for available components may be forced to sell those components for less.

Based on this difficulty in building and maintaining effective transactional relationships and communication with a large number of CSs and CBs, both CSs and CBs may use a component exchange to buy or sell components. For example, as illustrated in FIG. 2, a both CSs 210 and CBs 220 may use a component exchange 230 to sell or buy components. By using the exchange 230 to transact business with other entities, it is not necessary for a CS 210 to have a pre-existing relationship with a CB 220 to conduct a sales transaction. Rather, the component exchange 230 may act as or utilize a broker(s) or trader(s) to facilitate a transaction that serves both the interests of the seller 210 and the buyer 220. Additionally, the exchange may receive some compensation based on the sales transaction, the size of that transaction and/or on a subscription fee for providing the exchange service.

FIG. 3 illustrates one implementation of the exchange 230 illustrated in FIG. 2. As shown in FIG. 3, the exchange 230 may comprise an input/output interface 310, a component market memory 320, a processor 330 and an operational memory 340 coupled together via a communication and data bus 350. The input/output interface 310 may include one or more interfaces that allow users, e.g., traders, brokers and/or administrators, associated with the exchange 230 to interact with the exchange 230 to issue offers for sale or to buy components and to execute trades of components via the exchange 230. The component market memory 320 includes data related to the component market, for example, an archive of trades that have previously been executed. Additionally, the component market memory 320 may store data associated with entities using the exchange, i.e., billing data, shipping addresses, etc. The processor 330 may be implemented using one or more conventional data processors, CPUs, etc. The processor 330 includes a buy/sell data comparator module 332 and a request data analyzer module 334. The request data analyzer module 334 serves to analyze data entered via the interface 310 to identify relevant data associated with an offer or trade, i.e., the particular component(s) to be bought or sold, the quantity, the price, etc.

Once this data has been identified for a particular order, the buy/sell data comparator module 332 compares data associated with the order with other pending orders for compatibility, i.e., to identify a match or similarity based on component type, quantity, price, etc. The processor 330, and its constituent parts, operate based on operational instructions stored in the operational memory 340 to perform the above-mentioned functions. The input/output interface 310, component market memory 320, processor 330 and operational memory

Part of identifying which components should be purchased requires a determination of which components fulfill the needs of the DM. It is well known that DMs (or contract manufacturers building devices for these DMs) of devices including one or more components often perform extensive design tests and modeling to determine what components and types of components may be included in the devices to be manufactured. This process determines various specifications required of components to be used in the device, for example, minimum, maximum and/or preferable ranges of operating characteristics such as speed, electrical characteristics, capacity, etc. as well as component size and reliability. Thus, it is routine for design engineers to spend large amounts of time and effort to determine which components may be used in a particular device to be manufactured. As a result, such engineers determine required specifications of components to be included in a particular device.

It is also not uncommon, and in fact, is common, for such design engineers to identify more than one manufactured component that meet the specification requirements for use in a device (often referred to as a “design-in process”). Doing so allows DMs to minimize the effect of or avoid component shortages on any one component during device manufacture. Performing the design-in process may involve the DM assigning an Internal Part Number (IPN) to a particular location, functionality or slot(s) within the device to be manufactured. This IPN may identify the internal slot in the device to be manufactured, the slot being the location where the component is to be located. As a result, of the design-in process the engineer(s) may identify one or more manufactured components, which may be used for the particular IPN. These identified components are hereafter referred to in this application as “approved substitute components”.

However, each of these manufactured components is associated with a Manufacturer Part Number (MPN) by the manufacturer of that component. Thus, a DM associates their IPN with one or more MPNs. These MPNs are often unique sets of alphanumeric characters assigned by the CMs.

While some CMs offer suggestions for equivalent MPNs associated with competitors, the number of suggested equivalent components identified is often quite limited so as not to unnecessarily reduce the customer base available to the CMs. However, there may be mistakes, omissions or mischaracterizations in the list of suggested equivalent components, which limits the comprehensive nature of the suggestions offered. Thus, the engineer(s) cannot rely completely on the data provided by the CMs.

During the design-in process, design engineers may refer to various data sheets associated with MPNs to determine which MPNs should be analyzed as potential substitute components. The operating conditions associated with the measurements included in datasheets may not be identical. Therefore, in the semiconductor device industry, for example, two CMs may use slightly different voltages when testing components. This may be done intentionally, for example, when one CM is interested in acquiring a portion of a component market from another CMs component. Alternatively, this usually is done unintentionally, as there are often no generally accepted testing condition specifications approved by component industries. As a result, the tested components may appear to have identical operating characteristics, e.g., response time, when in fact, if the components were tested using the same operating voltage, their operating characteristics would differ, sometimes significantly.

Moreover, two CMs, for example, may produce products with similar specifications and the parametric limits detailed in their respective datasheets may be identical. However, one component may not work in a particular device due to an application-specific problem, subtleties in operating performance or synergy with other components in the system.

Nevertheless, DMs are forced to identify substitute components for their IPNs and to use both their own identified list of approved substitute component and the lists of substitute components provided by CMs when determining which components to design with, purchase, sell, ship, etc.

### SUMMARY OF THE INVENTION

In accordance with at least one embodiment of the invention, a system and method for maintaining and utilizing component cross reference data are provided that enable at least one of traders at a component exchange and entities trading on that exchange to access a master cross reference list of components to guide component trading decisions.

In accordance with at least one embodiment of the invention, a system and method are provided that enable one or more Business To Business (B2B), on-line, trading exchange systems.

In accordance with at least one embodiment of the invention, a system and method are provided that enable cross referencing of IPNs with MPNs from CMs based on inferred equivalence analysis of various IPN design selections and the similarities therein.

In accordance with at least one embodiment of the invention, a system and method are provided that enable tracking IPN links to each CS and CB account.

In accordance with at least one embodiment of the invention, a system and method are provided that enable identification of components that are approved substitute components and/or inferred equivalent components for a particular IPN.

In accordance with at least one embodiment of the invention, a system and method are provided for storing and linking subsets of approved substitute components (identified by at least one CB) and/or inferred equivalent components (identified through inferred equivalence analysis), and CBs and/or CSs associated with those subsets.

In accordance with at least one embodiment of the invention, a system and method are provided that allow access to data associated with component trading, the system and method including security mechanisms that allow for at least two levels of security associated with parts of that data and entities accessing that data.

In accordance with at least one embodiment of the invention, a system and method are provided that support a platform for trading components between entities based on data about substitute components to solve component shortages or surpluses.

In accordance with at least one embodiment of the invention, a system and method are provided that support decision support capabilities to CBs and CSs via at least one of commodity insights, price transparency, component number referencing and federated content management.

In accordance with at least one embodiment of the invention, a system and method are provided that support at least one of collaborative tools, real-time or near real-time design review, action item tracking, and configurable business processes and workflows. The system and method may also provide a secure collaborative environment, highly configurable business processes and workflows, online efficiency and document management for better version control.

In accordance with at least one embodiment of the invention, a system and method are provided that allow for exception-based planning across multiple tiers of a supply chain and configuring to customer business models and processes to gain maximum efficiencies. The system and method may also provide CSs with (This was the PLAN module . . . now defunct) improved management and control, uniform data, and reduced need for costly expedites and buffer inventory.

In accordance with at least one embodiment of the invention, a system and method are provided that enable at least one of reduction of component procurement cycle time, elimination of manual component sorting and processing, creating a comprehensive audit trail and improving access to competitive pricing and available component inventories.

In accordance with at least one embodiment of the invention, a system and method are provided that enable CBs to leverage market size to at least one of source components in time-sensitive situations, create links with component suppliers and eliminate communicative inefficiencies and gain extensive reach to global inventory. Additionally, the system and method are configured to allow CSs to liquidate component inventory quickly without compromising demand for currently offered component inventory, reduce inventory liability by accessing a large community of CBs or by selecting specific participants, and leveraging the global market to improve margin and extend global customer reach.

In accordance with at least one embodiment of the invention, a system and method are provided that enable CBs to centralize data for increasing productivity and easily engaging new global CBs and CSs. The system and method are also configured to improve efficiency in CB and CS logistic processes, enhancing business through optimization of the entire supply chain.

Additional features and advantages of the invention are set forth in the description that follows, and in part will be apparent from the description, or may be learned by practice of the invention. The benefits and advantages of the invention will be realized and attained by the system particularly pointed out in the written description hereof as well as the appended drawings.

### BRIEF DESCRIPTION OF THE DRAWINGS

The utility of the embodiments of the present invention will be readily appreciated and understood from consideration of the following detailed description of the invention embodiments, when taken with the accompanying drawings, in which same numbered elements are identical and:

FIG. 1 illustrates a conventional component market place;

FIG. 2 illustrates a conventional component exchange within a conventional component market place;

FIG. 3 illustrates the conventional component exchange illustrated in FIG. 2 in greater detail;

FIG. 4 illustrates a component exchange designed in accordance with at least one embodiment of the invention;

FIG. 5 is a first illustrative example for explaining component equivalence analysis;

FIG. 6 is a second illustrative example for explaining component equivalence analysis;

FIG. 7 is an illustrative example of an intermediate Master Cross Reference (MCR) data structure used in equivalence analysis;

FIG. 8 illustrates is an illustrative example of one implementation of the MCR data structure;

FIG. 9 is an illustrative flowchart illustrating one implementation of a process for populating the MCR data structure; and

FIG. 10 is an illustrative flowchart illustrating one implementation of a process for analyzing data content provided by trading partners to ensure accurate and up-to-date data and populate the MCR data structure.

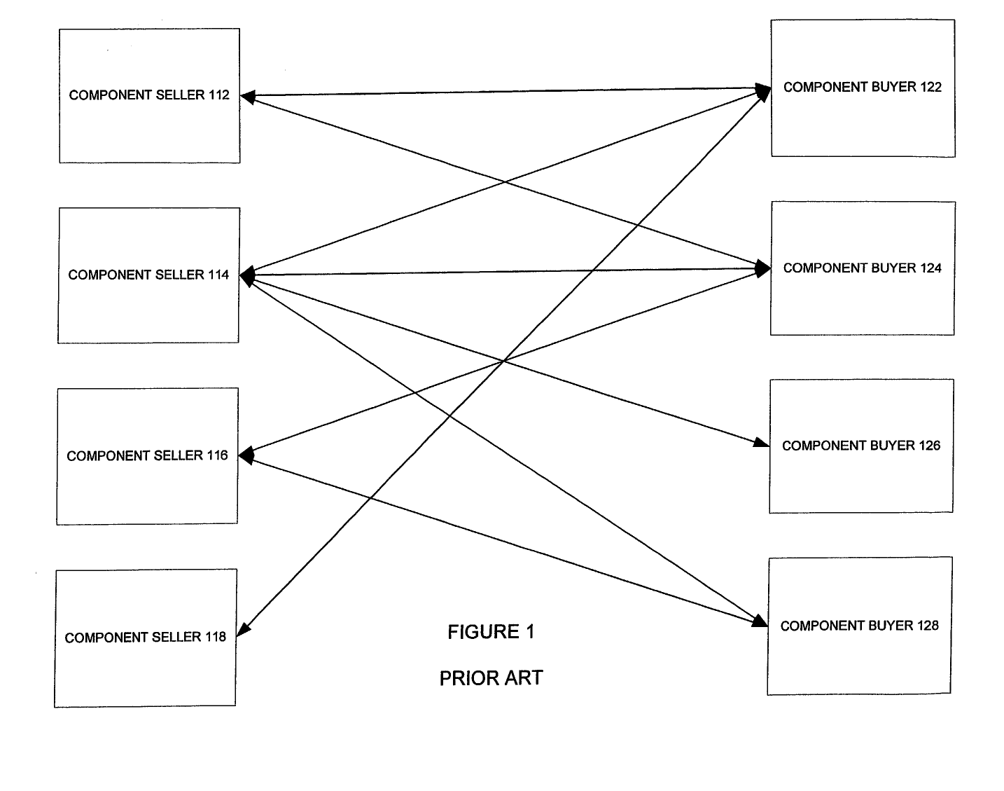

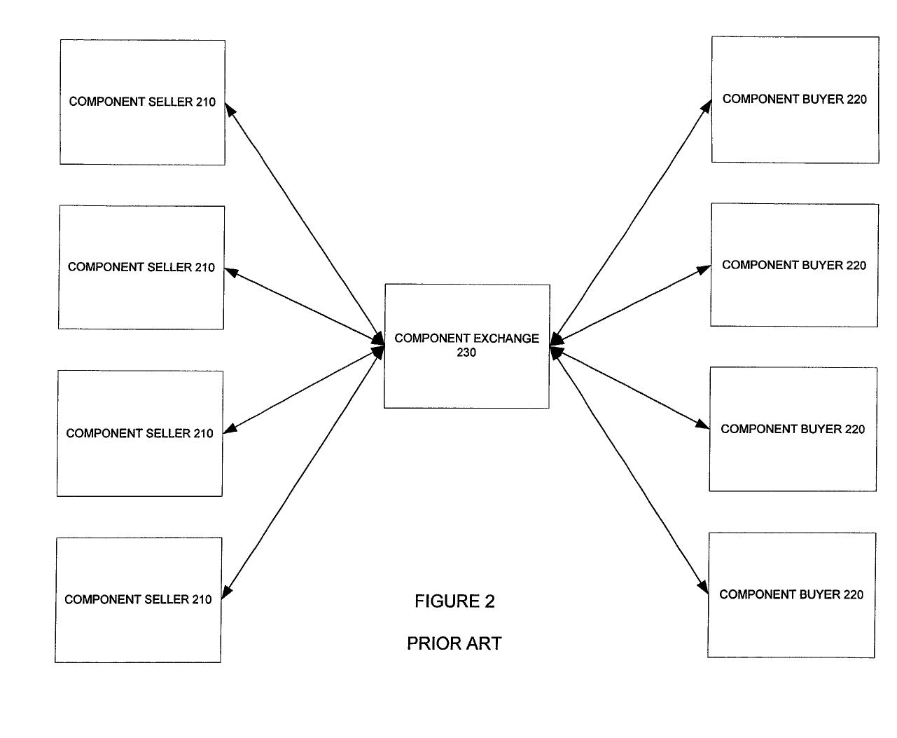

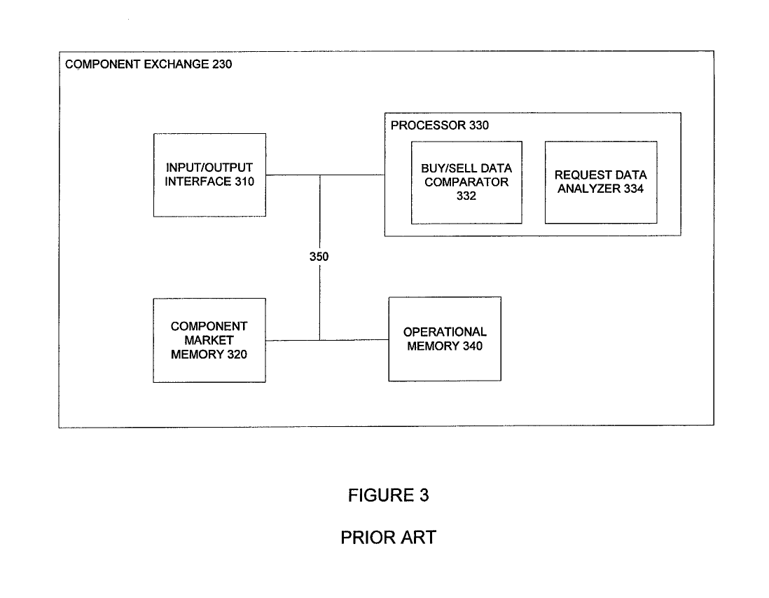

### DETAILED DESCRIPTION OF INVENTION EMBODIMENTS

For reference and clarification of the explanation of the exemplary embodiment of the invention, the following explanation of terminology is provided. Approved Substitute Components (ASCs) are components that are specifically approved for implementing a particular IPN. Inferred Equivalent Components (IECs) are additional possible substitute components that may be identified based on inferred equivalence analysis, described herein. IECs are components that may be considered by the DM or design engineer for possible inclusion as an ASC for a particular IPN based on data known about specifically ASCs associated with the IPN and other components' relationships with those ASCs. A trading partner is any entity interacting with the exchange system or the system and method for maintaining and utilizing cross reference data included or supported by that system. Therefore, a trading partner may be, for example, a CB, CS, DM, middleman, contract manufacturer, or any supply chain partner associated with any of those entities and providing data to the systems and methods designed in accordance with at least one embodiment of the invention.

The U.S. provisional application Ser. No. 60/246,605 made reference to the term “parts”, which should be understood to mean “components” as that term is used in this application. It should be understood that the embodiments of the invention may be utilized in the context of trading, i.e., buying, selling, etc., of any components; the invention is not limited to the trading of semiconductor components or high-technology-related components.

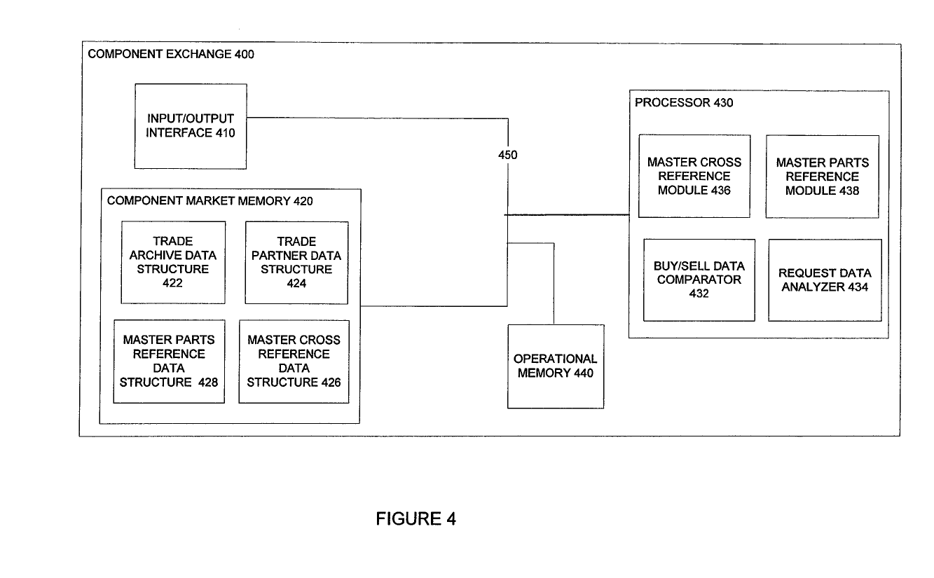

FIG. 4 illustrates one implementation of an exchange system 400 designed in accordance with at least one embodiment of the invention. As illustrated in FIG. 4, the exchange 400 may comprise an input/output interface 410, a component market memory 420, a processor 430 and an operational memory 440 coupled together via a communication and data bus 450. The input/output interface 410 may include one or more interfaces that allow users and/or administrators associated with the exchange system 400, and potential trading partners to interact with the exchange system 400 to issue offers to sell or buy components, to execute trades of components via the exchange system 400 and to access various tools included in or supported by the exchange including, a plan module, knowledge module, design module, etc.

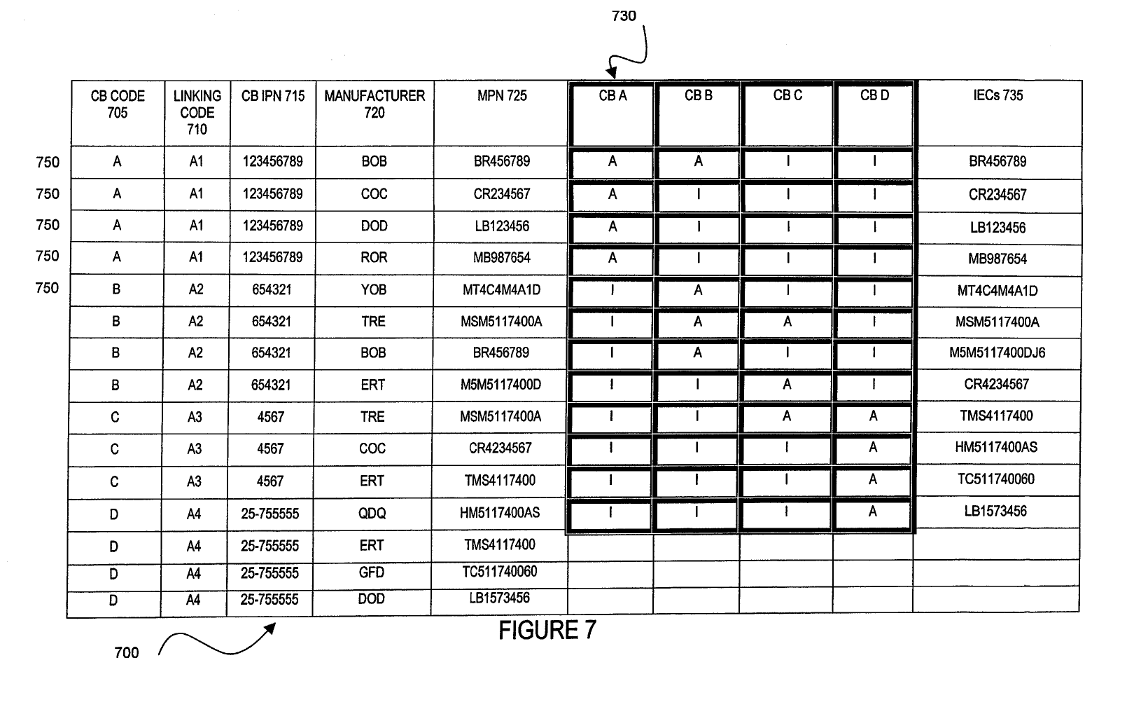

The component market memory 420 includes data related to the component market. Specifically, the component market memory 420 may include a trade archive data structure 422 storing, for example, an archive of trades that have previously been executed. The component market memory 420 may also include a trade partner data structure 424 including data associated with entities using the exchange, i.e., billing data, shipping addresses, etc. The component market memory 420 may also include a Master Cross Reference (MCR) data structure 426 storing data about ASCs and IECs, as explained below with reference to FIGS. 7-9. The component market memory 420 may also include a Master Parts Reference (MPR) data structure 428 which includes data associated with previously made trades, traded components and trading partners, this data being trusted to some increased extent as being accurate and reliable and maintained as a reference database to be such.

The processor 430 may be implemented using one or more conventional data processors, CPUs, etc. The processor 430 may include, but is not limited to, a buy/sell data comparator module 432, a request data analyzer module 434, a master cross reference module 436 and a master parts reference module 438. The request data analyzer module 324 may be configured to analyze data entered via the interface 410 to identify relevant data associated with an offer or trade, i.e., the particular component(s) to be bought or sold, the quantity, the price, etc. Once this data has been identified for a particular order, the buy/sell data comparator module 432 compares data associated with the order with other pending orders to identify a match based on component type, quantity and price.

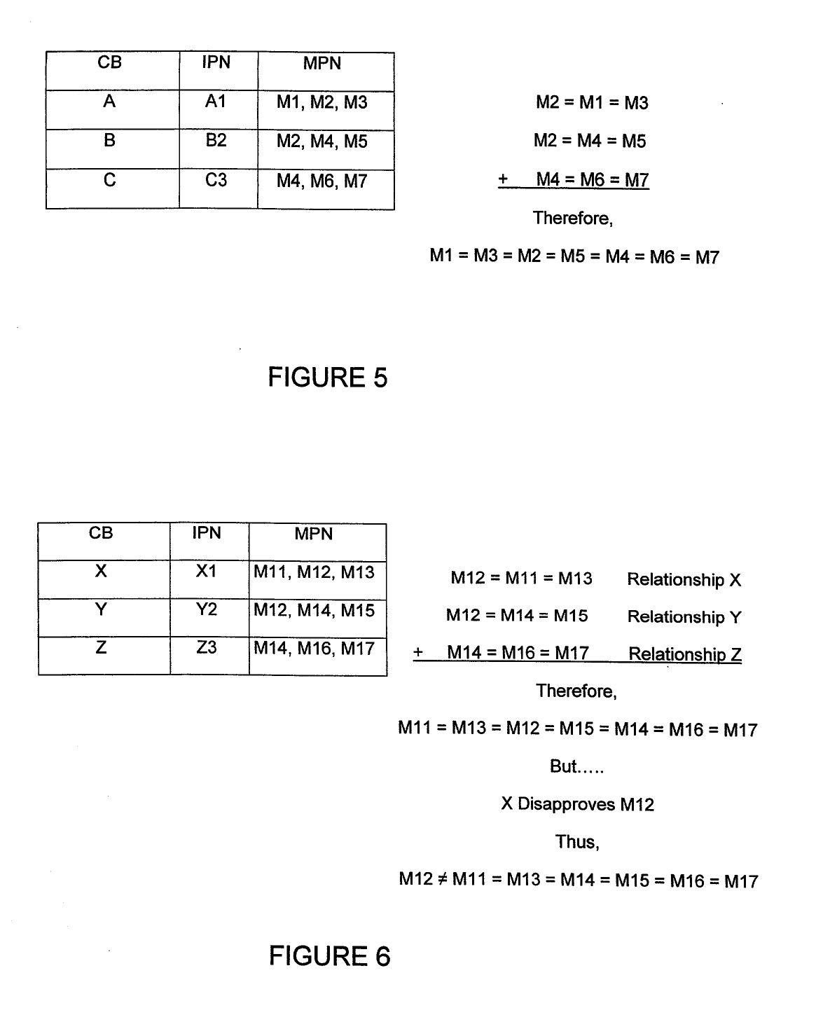

The MCR module 432 is configured to organize and analyze component cross reference data based on data provided by one or more trading partners, as explained below with reference to FIGS. 5-9.

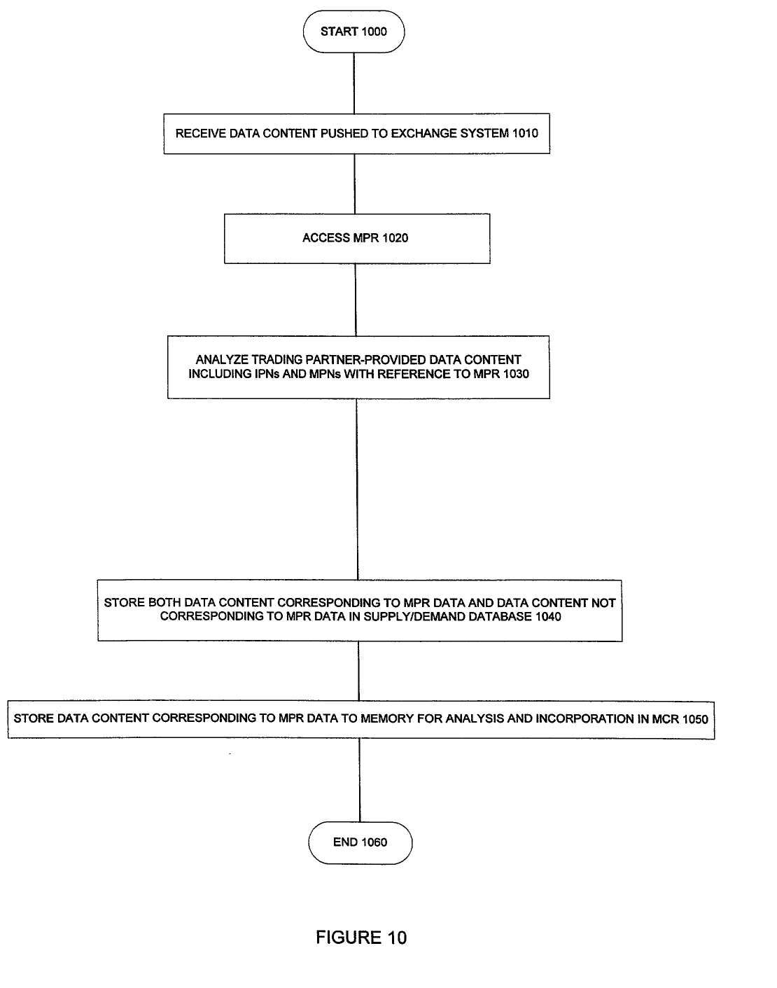

The MPR module 438 is configured to analyze data provided by one or more trading partners to identify errors, omissions and/or new information in data provided by trading partners. As explained in detail below with reference to FIG. 10, the MPR module 438 may be configured to validate a CBs IPNs and MPNs for standardization and incorporate this data into the MPR data structure 428 and output the data to the MCR module 432 for the module 432 to analyze the data and include it in the MCR data structure 426. The MPR module may also output the validated data as transaction data to, for example, the buy/sell data comparator 432 or the request data analyzer 434.

The MPR module 438 is configured to improve data quality before processing validated MPNs in the MCR module 436. As a result, invalid component numbers provided in supply data sent to the exchange system 400 may be handled differently than validated data, e.g., the invalid data may not be displayed on a GUI and/or web-site associated with the exchange system 400.

The processor 430, and its constituent parts, operate based on operational instructions stored in the operational memory 440 to perform the above-mentioned functions. The input/output interface 410, component market memory 420, processor 430 and operational memory are coupled together and interact through the communications and data bus 450.

FIG. 5 is an illustrative example for explaining component equivalence analysis that uses transitive properties (i.e., if X=Y and Y=Z then X=Z) to identify potential component equivalencies. As shown in FIG. 5, CB A is interested in purchasing components to be used for its IPN A1. As shown in the table included in FIG. 5, CB A has approved various ASCs (M1, M2 and M3) for implementation of its IPN A1. That is, MPN components M1, M2 and M3 may be used for IPN A1. CB B has an IPN B2; CB B has approved ASCs (M2, M4 and M5) for implementing its IPN B2. CB C has IPN C1, for which it has approved ASCs (M4, M6 and M7) for implementation of the IPN C1.

Generally, CBs A, B and C procure only approved components for each of their respective IPNs. However, MPN component M2 is approved for implementing both the IPNs A1 and B2. Therefore, an inference may be made that those components that are ASCs for the same components as M2 are possible equivalent components of each other, barring any application specific issues. Therefore, an inference may be made that M1 and M3 (which are ASCs along with MPN M2 for IPN A1 determined by CB A) are, indeed, potential inferred equivalents for MPNs M4 and M5 (which are ASCs along with MPN M2 for IPN B1 determined by CB B), and vice versa.

Similarly, as shown in FIG. 5, CB C has specifically approved MPNs M4, M6 and M7 as ASCs for IPN C1. MPN M4 is also an ASC for IPN B2. Thus, the inference may be made that MPNs M6 and M7 (which are ASCs for IPN C1 along with MPN M4) are potential equivalent components for MPN M2 and M5 (which are ASCs for B1 along with MPN M4).

Further, by logical deduction it may be inferred that those components that are IECs of M2 are also possible IECs for each other. Therefore, because MPN M2 was approved by CBs A and B, it may be inferred that all components that may be equivalent to M2 may be equivalent to each other. Thus, an inference may be made that M1-M7 are all IECs for one another. This is because M1, M3, M4 and M5 are IECs for M2 and M2, M5, M6 and M7 are IECs for M4.

Based on this inferred equivalent analysis, CBs A, Band C may be able to use a larger set of potential components rather than being limited only to those ASCs that they have specifically approved though their design-in process performed by their design engineers. Therefore, if a CB's ASCs are not available during a particular period of device manufacture, data about potential IECs will be very valuable to it.

As a result, in accordance with at least one embodiment of the invention, the MCR module analyzes data indicating ASCs for use with associated IPNs and cross references the MPNs on the ASC lists to identify IECs, thus producing a subset or list of IECs. These IEC lists may then be used to provide various services and products to CBs and CSs to more easily identify the components they are interested in purchasing or the markets to which they should be selling, respectively.

The subsets of IECs resulting from the inferential analysis may be stored along with the identity of the CBs associated with the IPNs and the IECs in the MCR data structure. Thus, this data structure includes identification of particular IPNs, the associated trading partners, the associated ASCs and IECs.

Furthermore, at least one embodiment of the invention may include an inference action history that indicates, chronologically, what inference analysis has been performed regarding component substitution and what data lead to specific inferences. In this way, the integrity of the MCR data structure may be maintained in the event that data about ASCs is inaccurate. For example, as shown in FIG. 6, suppose a CB X indicates that ASCs for its IPN X1 include MPNs M11, M12 and M13 (referred to as the X-asserted relationship). Additionally, CB Y subsequently indicates that the ASCs for its IPN Y2 include MPNs M12, M14 and M15 (referred to as the Y-asserted relationship). Further, CB Z indicates that the ASCs for its IPN Z3 include MPNs M14, M16 or M17 (referred to as the Z-asserted relationship).

Based on that data, the MCR module may infer that MPNs M11, M12, M13, M14, M15 and M16 are equivalent to M17. This is because M12 and M13 and M11 are ASCs (based on the X relationship). MPN M11 is also an ASC along with M17 and M14 (based on the Z relationship). M14 is also an ASC with M15 and M16 (based on the Y relationship). However, supposing that CB X disapproves, M12, then there is an insufficient data to make that inference. As a result, M12 may not be inferred to be equivalent to any of M11 and M13-17. Moreover, inferences may not be made about M15 or M13 with respect to equivalence with M16 or M17 because there is no mutual equivalence that may be relied upon to infer further.

Thus, it should be appreciated that because this inferred equivalency analysis of MPNs is based on a plurality of applied inferences, the MCR module may archive data indicating the chronological order in which inferences are applied to the data stored in the MCR data structure so as to allow for correction of the consequences of improper inferences. Maintenance however may be achieved through the use of the Universal Part Number (UPN). If an MPN is suddenly no longer approved for use in a manufacturing environment, the maintenance module gets that records UPN and all records reflecting that same UPN are set to null and the maintenance module is run again to reset the appropriate UPNs for proper linkage. Additionally, the MCR module may also register and store the identity(s) of entities providing such inaccurate data. This indication of whether equivalency data is provided by previously inaccurate sources may allow the system and/or system operators or administrators to prioritize the equivalency data and treat it accordingly, e.g., analyzing it differently, setting a flag associated with the equivalency indicating its questionable source, only implementing equivalency actions based on the data when the questionable equivalency data has been confirmed from another data source, etc.

FIG. 7 is an illustrative example of an intermediate MCR data structure used in equivalence analysis performed in accordance with at least one embodiment of the invention. As shown in FIG. 7, the linking code the data structure 700 may include a plurality of records 750 indicating a relationship between an IPN and various MPNs. As shown in FIG. 7, each record 750 may include fields associated with a CB code 705, linking code 710, CB IPN 715, manufacturer 720 and associated MPN 725 and identified IEC(s) 730 if any. For illustrative purposes an intermediate data structure 735 is included to better illustrate how IECs are identified. As shown in intermediate data structure 735, the ASCs are flagged. Subsequently, the IECs are identified through the inferred equivalence analysis. As shown in structure 735, indication of the ASCs and IECs is included in each record 750.

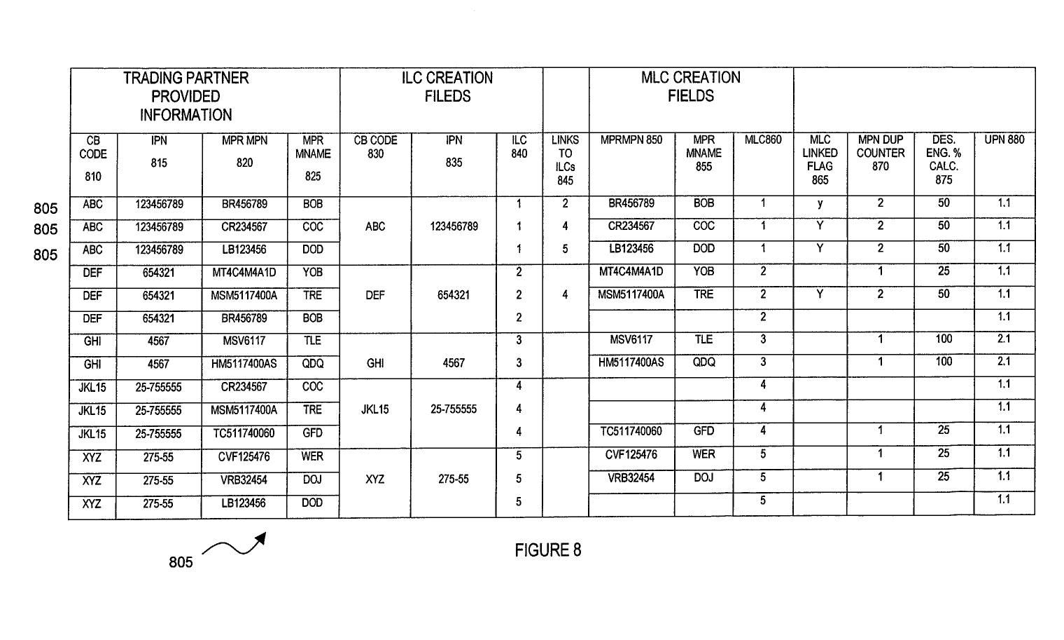

A Universal Part Number (UPN)—(as explained in FIG. 8) is assigned to each unique combination of CB code and IPN. This UPN allows linking of an external user's IPN to ASCs and IECs. It should be understood that the inferred equivalence analysis is controlled by referencing codification within the UPN, The ILC and the MPC and is referenced in detail in FIG. 8.

FIG. 8 is an illustrative example of one implementation of the MCR data structure. As shown in FIG. 8, the MCR data structure may include multiple records 805, each record including, among other things, a CB code 810, IPN 815, and MPR manufacturer part/component numbers (MPR MPN) 820 and MPR manufacture names (MPR MNAME) 825. This data is provided by entities trading on the exchange system. The Internal Linking Code (ILC) Creation Fields are populated second with one entry in each column for each unique combination i.e., CB code 830 and IPNs 835. The ILC field 840 is populated with a “1” for the first unique combination and each subsequent unique combination is populated to reflect a value equal to the previous unique ILC number plus one. When populating the ILC creation fields, each unique combination of CB code and IPN is only listed once and assigned the next ILC number chronologically, i.e., last previously used ILC plus one. The ILC creation fields also include a field 845 indicating the records to which the record is linked to via reference to the same ASC.

The MLC creation fields are then populated, entering only unique MPR validated MPNs 850 and manufacturer name (MNAME) 855 combinations and an MLC value 860, which reflects the same ILC value as was assigned to the unique CB code/IPN combination and entering a one in the MPN duplication counter (MPN DUP COUNTER) field 865. If a combination of the MPN 850 and MNAME 855 already exists in the MLC creation fields, several actions may take place. For example, the existing record should have its MPN DUP COUNTER value increased by one to reflect an additional design engineer has chosen to design-in that MPN/MNAME combination. The record being added to the data structure whose MPN/MNAME combination already existed would not have any entry in the MLC creation fields but would capture the existing entry's UPN as its own UPN 880. The MLC LINKED FLAG field 870 would be populated with a “Y” to indicate the existence of a record with an MPN/MNAME combination that is linked to the existing record. When populating the MLC creation fields, each unique MPN/MNAME combination is only listed once in the MCR data structure and assigned the same MLC value as that record's ILC.

The UPN (Universal Part Number) is populated next by entering a “1.1” in the UPN field 880 for the first unique CB code/IPN combination entered. The UPN continues to be populated with this entry until the CB code/IPN combination changes, at which time it would be entered as the last records' UPN number plus one.

The “Des. Eng. % Calc” field 875 is populated based on a determination for each record by taking that record's “MPN DUP. COUNTER” value and dividing it be the total number of unique CB code/IPN combinations that share the same UPN as the record that is being analyzed.

If a CB dis-appoves, i.e., retracts its designation of, a particular MPN as an ASC, an indication of this disapproval, e.g., an additional data field may be included in the MCR data structure that provides an indication of the dis-approval. However, it may be useful to maintain the dis-approved record in the data structure. Thus, the dis-approved record may be included in the finite set of unique IECs associated with a particular UPN.

The MCR data structure 800 may also include an additional data field that indicates history of each record. This history may be used to undue incorrect operations performed based on inaccurate data provided by a trading partner. For example, a trading partner may provide data that may indicate that a particular IPN ABC has approved MPNs 123, 456 and 789. However, it may later be determined that MPN 789 is not an ASC. However, based on the previously provided data, the finite sets of MPNs associated with UPNs may be inaccurate. By including history data of each line item, the data structure may be cleansed of the incorrect data and UPNs may be re-assigned. The history data may include an indication of the date and/or time when the inaccurate data was analyzed. Additionally, a known disapproved ASC from a particular CB would be flagged and its UPN noted. Maintenance may then require all records with that same UPN be set to ‘null” or blank. Subsequently, a maintenance program is then run to properly re-assign corrected linkage in UPN assignments to mitigate complications throughout the MCR database and application that may have been effected by improper associations caused by the disapproved ASC record. Therefore, the data within the MCR data structure may be re-analyzed to insure correct associations.

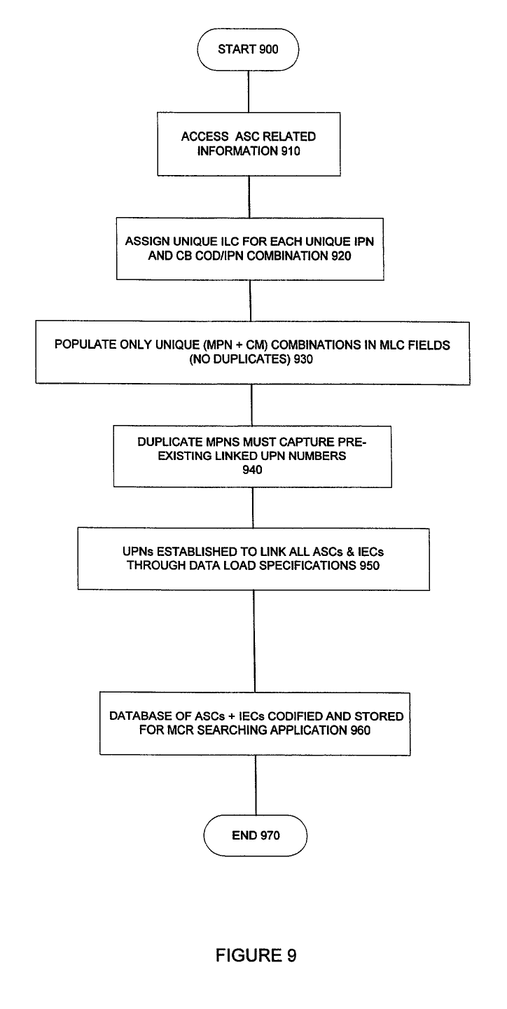

As shown in FIG. 9, parts of the MCR data structure illustrated in FIG. 8 may be populated using the illustrated procedure. As shown in FIG. 9, such a procedure begins at 900 and control proceeds to 910. At 910, ASC data is accessed, e.g., by downloading or inputting that data provided by trading partners, accessing this data previously stored in a memory, etc. Control then proceeds to 920, at which an ILC value is assigned for each unique CB code/IPN combination. At 920, the ILC value is the same as the MLC value for all ASCs associated with the ILC value. Control then proceeds to 930, at which MLC fields are then populated only with unique MPN+CM combinations. Control then proceeds to 940 at which duplicate MPNs are identified and capture the pre-existing UPN.

Control then proceeds to 950, all UPNs have been established through the data load specification to link all ASCs and IECs, effectively synthesizing the data using the transitive property explained above, (i.e., if A=B and B=C, then A=C) and sharing the same Universal Part Number for ASC and IEC identification purposes. Control then proceeds to 960, at which the database of IECs and ASCs is codified with ILC, MLC and UPN distinctions and output and/or stored for subsequent searching or use. Control then proceeds to 970, at which the procedure ends.

Subsequently, additional data may be added to the lists of IECs and ASCs to produce the MCR data structure shown in FIG. 8. Additionally, additional operations, such as calculating the design-in engineering percentage calculation, may be performed. This is all accomplished through maintenance processes which are automated.

As explained above, prior to operation of the MCR module to perform ASC and IEC analysis via sorting and inferred equivalence analysis, the data must be validated using the MPR module. As briefly explained above, the MPR module, validates data associated with a CBs IPNs and MPNs for standardization and is analyzed and transformed by the PNI (Part Number Integrity) Analysts, who incorporate this data into the MPR, MCR data structures and outputs the validated data to other modules in the processor for transaction purposes. Thus, the MPR module enables standardization through the PNI analyst validation of data against a master list of components, manufacturers, classes and categories to enhance value for system exchange trading partners stored in the MPR data structure and populated based on data content provided originally by trading partners.

For example, FIG. 10 illustrates one procedure for populating the MCR data structure while comparing pushed data content provided by trading partners with a master list of components, manufacturers, classes and categories stored in the MPR data structure. As illustrated in FIG. 10, the procedure begins at 1000 and control proceeds to 1010. At 1010, data content pushed to the exchange system is received. Control then proceeds to 1020, at which the MPR data structure is accessed to make available previously stored reference data. This reference data may be provided by potential trading partners at various points in time during their interaction with the exchange system. Control then proceeds to 1030, at which potential trading partner data is analyzed with reference to the data stored in the MPR data structure. The analyzed data includes, but is not limited to, IPNs and MPNs identified in the potential trading partners' data content.

Control then proceeds to 1040, at which data content is stored in a supply/demand data structure regardless of whether it matches data content in the MPR data structure or it is unknown or inaccurate. The supply/demand data structure may be utilized by other exchange system modules, e.g., trade module, etc., explained below to determine or forecast component market conditions and trends.

Control then proceeds to 1050 at which data content matching that stored in the MPR data structure is stored in memory for analysis and subsequent incorporation in the MCR data structure. Control then proceeds to 1060, at which the procedure ends.

Subsequent to population of the MCR data structure, users may search it for various different purposes. For example, any user may enter a combination of MPN and manufacturer name and capture the identification of the corresponding UPN. This UPN may be used to search for approved substitute components with the same UPN as well as inferred equivalent components. Finite sets of ASCs and IECs may be generated by searching an MPN by grabbing its UPN and matching to all records with equal UPNs, retrieving all applicable MPNs and eliminating duplicates. Additionally, users provided with authorization may be allowed to perform additional searches.

For example, when a user enters an IPN, the system for maintaining and utilizing component cross reference data may be configured to identify the trading partner associated with the IPN and use the IPN and associated identity data to perform component searches in the MCR data structure. Such component searches may include, e.g., entering an MPN value to capture data indicating ASCs and IECs. This may be performed by entering an MPN value and a component manufacturer name. Subsequently, the system may capture the records of the UPN associated with that MPN. The system may then output a list of all matching MPN manufacturer combinations in an alphanumeric sorted list, omitting any duplicates.

Additionally, a user may use an IPN to identify ASCs. This may be performed, for example, using data indicating the IPN and the CB. Based on this data, the system may match records, e.g., ILCs against all MLCs, returning all combinations of MPN and manufacturer that match the identified ILC. These matches may be output to the user in an alphanumeric sorted list.

Also, a user may enter an IPN value to identify IECs. This may be performed, for example, using data indicating the IPN and the CB. Based on this data, the system may identify the corresponding UPN value and capture all records having that UPN value. The system may then list all matching MPNs and associated manufacturers in an alphanumeric sorted list, omitting any duplicates. Also, the system may omit records which include the same MLC as the searched upon ILC to remove ASCs from the returned records, thereby providing only IECs.

In the event that the user wants to search for both ASCs and IECs, a user may enter data indicating the IPN and the CB name. Based on this data, the system may identify the corresponding UPN value and capture all records having that UPN value. The system may then list all matching MPNs and manufacturers in an alphanumeric sorted list, omitting any duplicates. Additionally, ASCs may be separated from IECs by sorting based on whether the MLC in each record matches the ILC of the subject IPN of the search. Based on this sort, a flag may be set for each record that is an ASC record or an IEC record, or both.

As a result, the exchange system's user interface(s) may include Graphical User Interfaces (GUIs) that allow users to enter data indicating IPNs, MPNs and CB or CM names as well as the type of search of the MCR to be performed, e.g., perform a search for ASCs, perform a search for IECs, perform a local search for IPNs associated with the user, perform a global search for IPNs associated with the user, In the case of local or global searches for IPNs associated with the user, results may include a location of the components.

It may be beneficial to limit the types of searches enabled by the system. Thus, traders/brokers and personnel associated with the exchange system may be the only users allowed to perform searches based on IPN, CB, CM or MPN data to capture data indicating different trading partners' IPNs linked to the same MPN. For example, using an IPN-CB identification data combination, the MCR module may identify the corresponding UPN and capture records associated with the UPN. Subsequently, the MCR module may match all records that have the same UPN, MPN and manufacturer identification data. As a result, the system may return a listing of the unique IPN, CBs' identification data, MPN, and manufacturer identification data corresponding with the input IPN/CB identification data combination. Additionally, the system may optionally indicate the trader(s) associated with each CB and/or CM. This data may allow traders/brokers to help each other to create trading matches for their clients.

Additionally, using a MPN/manufacturer identification data combination, the MCR module may identify the UPN and capture records associated with the UPN. Subsequently, the system may match all records that have the same UPN, MPN and manufacturer identification data. As a result, the system may return a listing of the unique IPN, trading partner identification data, MPN, and manufacturer identification data corresponding with the input IPN/manufacturer identification data combination. Additionally, the system may optionally indicate the trader(s)/broker(s) associated with each CB and/or CM. This data may also allow traders to help each other to create trading matches for their clients.

In accordance with at least one embodiment of the invention, the system and method for maintaining and utilizing component cross reference data and any exchange system including it may be used by individuals or organizations to search by MPN or IPN. For example, a user may search to identify a finite set of ASCs, IECs, DMs, IPNs or MPNs This may be done by searching by MPN or IPN, component manufacturer name, product class, category, part description, ECCN, Harmonized Tariff Numbers, customs part descriptions, etc. Moreover, any or all of this data may be viewed by searching using one of these criteria.

In accordance with at least one embodiment of the invention, the system and method for maintaining and utilizing component cross reference data and any exchange system including it may be used by individuals or organizations to select alternate and search using the plan module explained below.

In accordance with at least one embodiment of the invention, the system and method for maintaining and utilizing component cross reference data and any exchange system including it may be used by individuals or organizations to display linked IPNs including CB/account name, city state and country data, including IPNs linked (with the user's own organization or company).

In accordance with at least one embodiment of the invention, the system and method for maintaining and utilizing component cross reference data and any exchange system including it may be used to navigate to prices, trends, news, etc. provided by the exchange system.

In accordance with at least one embodiment of the invention, the system and method for maintaining and utilizing component cross reference data and any exchange system including it may be used by individuals or organizations to select and search against supply and demand, inventory positions and data generated by plan, order, trade and move modules described herein.

For example, in accordance with at least one embodiment of the invention, the system and method for maintaining and utilizing component cross reference data and any exchange system including it may be used by individuals or organizations using a knowledge module included within the exchange system. Such a knowledge module may be configured to provide decision support capabilities to CBs and CSs via commodity insights, price transparency, component number referencing and federated content management. The knowledge support module may also be configured to enable CSs to expand market reach and explore new revenue opportunities, access digital documents like white papers, data sheets, and product or market reports, and receive up-to-date industry data on current market trends. The knowledge module may provide a set of knowledge and data based tools and services that will help optimize CS and CB productivity. These tools may be designed to provide both visibility and insight into industry trends and product-specific data. For example, the knowledge module may provide pricing updates that may be viewed at or near real-time. Such pricing updates may provide commodity-specific pricing data and trend charts.

The knowledge module may also be configured to provide access to industry news and data via a real-time or near real-time scrolling article index. Additionally, the knowledge module may also be configured to provide links to industry news sites, manufacturer web-sites and one or more management reference tools. Further, the knowledge module may also be configured to provide access to news from the exchange system including, for example, commodity-specific market updates, forecasts and headlines.

A market place supported by the knowledge module may offer a robust repository of intellectual capital by providing a virtual community of companies and experts who have deep industry and niche-market expertise. As a result, trading partners can share, sell and purchase industry-specific data, data and related resources from experts in, for example, manufacturing, market analysis, global logistics, international trading regulations, and more.

In accordance with at least one embodiment of the invention, the system and method for maintaining and utilizing component cross reference data and any exchange system including it may be used by individuals or organizations using a design module included within the exchange system. Such a design module may be configured to provide CBs with collaborative tools, real-time or near real-time design review, action item tracking, and configurable business processes and workflows. The design module may also be configured to benefit suppliers through its secure collaborative environment, highly configurable business processes and workflows, online efficiency and document management for better version control.

The design module may be configured to provide a collaborative design environment that enables the integration of people, processes, and technology, resulting in more efficient component and device product design. The design module may integrate with CS and CB enterprise systems and Information Technology (IT) architecture, and their partners. As a result, the design module may enable a secure platform where original design reviews and revisions can occur at or near real-time, and with complete visibility by all parties.

The design module may be configured to help CBs and CSs control project costs by automating administrative activities such as document approval and routing. In cooperation with the knowledge module explained above, the design module may provide a single, searchable data structure of components, as well as a component-matching engine that enables cross-referencing.

Therefore, the design module may assist CBs and CSs to control costs, improve device development, and speed time-to-market, so that DMs can deliver high-quality products on time and on budget.

The design module may be implemented as a secure, web-based collaborative design environment. The design module may provide tools for each phase of the device development cycle-from concept and design through prototyping and development. The design module may also include a project management module that may include project tracking capability, supply chain visibility and management tools, project reporting and metrics, and document management. The design module may also include a Bill of Materials (BOM) management module that may be configured to allow users to electronically create, share, and process development BOMs. By using the system to provide cross referencing data including inferred equivalent data, BOM line items may be translated, identified and matched against exchange supply/demand metrics efficiently.

The design module may also be configured to provide a private workspace module that supports action item tracking, milestone alerts, reporting, and document management tools. The design module may be configured to support structured collaboration; as a result, the module may be configured to support complex sourcing negotiations, approval routing, and ad hoc business-to-business workflow modeling, including links to the enterprise system of record. It should be understood the design module may also be configured to support unstructured collaboration, which may enable design reviews (such as designing for manufacturability, serviceability, reliability, and supply chain availability), phase reviews, product visualization and markup, and ad hoc meeting management.

In accordance with at least one embodiment of the invention, the system and method for maintaining and utilizing component cross reference data and any exchange system including it may be used by individuals or organizations using a plan module included within the exchange system. Such a plan module may be configured to benefit CBs by reducing the need for costly expedites and buffer inventory, allowing for exception-based planning across multiple tiers of a supply chain and configuring to customer business models and processes to gain maximum efficiencies. The plan module may also be configured to provide suppliers with early alerting of potential delivery problems, improved management and control (including, for example, 3PL hubs), uniform data, and reduced need for costly expedites and buffer inventory.

The plan module may be configured to enable trading partners to collect, interpret, and respond to real-time supply and demand data. Regardless of the complexity of their supply chain—or how many different data systems their supply chain partners are using, the plan module may be configured to consolidate real-time supply and demand data. Additionally, the plan module may enable trading partners to access that data through a single standard view. Thus, such users and their supply chain partners can more accurately plan and forecast sales cycles, distribution strategies, and supply requirements.

The plan module may also allow trading partners to set minimum and maximum component inventory levels using trigger-based monitoring and alerting capabilities. In the event of an alert, the system may automatically provide real-time options based on historical trends and performance that can be used to resolve component inventory excesses or shortages. These capabilities are available regardless of where inventory is located, or how many supply chain partners require access to inventory-related data. In this way, the plan module may provide a solution that delivers full visibility, generates real-time alerts, and offers resolution tools for active management across the whole supply chain. The plan module also provides a collaborative solution that enables trading partners to collect, interpret, and respond to supply and demand signals in real time.

The plan module may provide visibility at any number of supply chain nodes, along with intelligent monitoring, alerting, and resolution capabilities that help identify adverse conditions and restore optimal capacity levels. This functionality may enable trading partners to achieve higher capacity-utilization levels and improved fill rates through more efficient and accurate matching of supply and demand. Additionally, this functionality may allow achievement of higher workplace efficiencies by allowing viewing data from various systems on a single page. Further, the functionality may enable lower inventory costs by keeping capacity at lowest appropriate levels, and actively re-balancing inventory based on automatic alerts. Moreover, it may enable lower shipping costs through better planning, eliminating the need for rush orders and expedited shipping. Finally, for CSs, sales may be increased through closer collaboration with supply chain partners.

In accordance with at least one embodiment of the invention, the system and method for maintaining and utilizing component cross reference data and any exchange system including it may be used by individuals or organizations using an order module included within the exchange system. Such an order module is configured to benefit CBs by helping to reduce procurement cycle time, eliminate manual sorting and processing, creating a comprehensive audit trail and improving access to competitive pricing and available inventories. The order module may also be configured to enable suppliers to lower individual costs of sales, reduce or eliminate manual invoice tracking, reduce costs associated with installing EDI programs to access only one customer, and improve access to large customers.

The order module may provide an integrated online solution that enables trading partners to collaborate electronically on price, quantity and delivery with all of the trading partners in their supply chain. By using the order module, inefficiencies and errors may be replaced by fast, secure and reliable electronic transaction processes. Electronic purchase orders (POs), advance ship notices (ASNs), and invoices, may be sent, acknowledged, altered and even canceled without wasting time and money tracking down the latest paperwork.

The order module may integrate an entire supply chain web by allowing supply chain partners multiple methods of accessing data. Companies can collaborate using a simple browser or connect their global ERP systems. Regardless of size, any enterprise can benefit from order module's capabilities. Through integration with other components such as the move module, trade module, and plan module, the order module may automate PO and ASN generation and trigger real-time or near real-time updates to sales, inventory and logistic data.

The order module may provide an integrated solution that enables CBs and CSs to collaborate electronically with all of the trading partners in their supply chains. The order module may offer various types of transactions to CBs, e.g., creating POs, viewing PO acknowledgements, creating PO changes, canceling POs, counter PO acknowledgements with changes, viewing prior shipping order notices, receiving ASNs, viewing invoice details, etc. Similarly, the order module may offer various types of transactions to CSs, e.g., acknowledging POs and PO changes, canceling POs, acknowledging canceled POs, counter offers, counter offer split line, creating sales orders, creating delivery orders, creating advance ship notice, creating invoices.

The order module may also offer various other features and benefits. For example, the order module may enable establishing and maintaining a single IT connection. Additionally, the module may enable issuance and completion of automated transactions. These features may result in the ability to engage in online collaboration, improved visibility in transaction processes, the ability to experience extensive IT infrastructure savings, lower barriers for CBs to switch between components and/or CSs, lower barriers to entry for CSs, elimination or minimization of manual transaction processing, reductions in error rates and optimization of transaction cycle times, and the opportunity to use comprehensive audit trails.

In accordance with at least one embodiment of the invention, the system and method for maintaining and utilizing component cross reference data and any exchange system including it may be used by individuals or organizations using a trade module included within the exchange system. Such a trade module may be configured to enable CBs to leverage market size to source product in time-sensitive situations, create links with component suppliers and eliminate communicative inefficiencies, and gain extensive reach to global inventory. The trade module may also be configured to allow CSs to liquidate FGI inventory quickly without compromising demand for current product, reduce inventory liability by accessing a large community of CBs or by selecting specific participants, and leveraging the global market to improve margin and extend global customer reach.

The trade module may provide CBs and CSs with the opportunity to initiate and participate in forward and reverse auctions. Forward and reverse auctions may be either public or private trading events. Forward auctions represent a “one-to-many”, CS-centric auction model where one CS (e.g., the auction originator) engages several potential CBs to outbid each other with upward, dynamic pricing actions in order to secure the CS's product or service. Reverse auctions represent a “one-to-many”, CB-centric auction model where one CB (e.g., the auction originator) engages several potential CSs to outbid each other with downward, dynamic pricing actions in order to secure the CB's product or service.

The trade module may be configured to support structured negotiation is an online multi-variate negotiation mechanism that leverages a structured framework designed to mitigate ambiguity and confusion among CBs, CSs and administrators of the exchange system. This structured framework may more clearly identify and facilitate the negotiation of both monetary and non-monetary trade variables such as price, shipping time, component quantity, etc. The trade module's structured negotiation may encompass both negotiable and non-negotiable offers to buy/sell and all offers may be binding and carried out in complete anonymity between trading partners. The mechanism(s) associated with and supporting structured negotiation may be most appropriate for standard commodity components.

The trade module may also support Requests For Quotes (RFQs)/Requests To Sell (RTSs) representing a “one-to-many” CB-centric/CS-centric trading models, respectively. CBs and CSs may submit RFQs/RTSs for any desired component to the trade module to source, generate competitive offers, negotiate legal contracts and produce invoices. Sourcing is one of the most time-consuming and, therefore, expensive steps in the traditional procurement process. The trade module may be used to reduce this cost by leveraging historical trading data to efficiently aggregate and match supply and demand within the market. Although RFQs/RTSs may be used in any trading circumstance, they are most useful when trades need to be executed very quickly or when specialized knowledge is required to locate CBs or CSs.

In accordance with at least one embodiment of the invention, the system and method for maintaining and utilizing component cross reference data and any exchange system including it may be used by individuals or organizations using a move module included within the exchange system. Such a move module may be configured to benefit CBs by centralizing data for supply chain performance tracking, improving the invoice reconciliation process, increasing productivity and easily engaging new global trading partners. The move module may also be configured to provide suppliers with centralized data for customer service performance tracking, an improved invoice reconciliation process, and visibility across all nodes, freight forwarders and carriers.

The move module may enable improved efficiency in trading partner logistic processes, enhancing business through optimization of the entire supply chain. The move module may be implemented as a collection of integrated transportation management services that provides full visibility to all component shipments and provides automated management of the complete logistics process. The move module may provide various features including SKU level visibility to shipments, across all nodes, carriers, and processes, centralized contract management to effectively control all aspects of logistics, automated shipment processes including booking, rating, routing and compliance, aggregation of traffic across a particular market sector, and optimization of shipments through analysis of shipping patterns. As a result, CBs and CSs may experience and more extensive visibility, which reduces uncertainty in the supply chain, reducing the need for buffer inventories, more efficient logistics management via automated tracking of shipment performance, which may allow more easy identification of improvement opportunities. Additionally CBs and CSs may experience cost reduction because fewer delays lead to less expediting, reducing the logistics costs while maintaining service levels. Further, security may be improved because every transaction is secure, with data sets protected and restricted to authorized trading partners.

In accordance with at least one embodiment of the invention, the system and method for maintaining and utilizing component cross reference data and any exchange system including it may be used by individuals or organizations using a connection module included within the exchange system. Such a connection module is configured to provide CBs with a faster and more predictable partner integration effort, integration cost containment through proven project methodology, and the option of utilizing current business connections through different protocols for leveraging future connections. The connection module may also be configured to provide suppliers with lower integration entry costs resulting in faster partner adoption rate, utilization of web-based project management site for up-to-date project status, and faster creation of liquidity for the hub and therefore faster value realization.

The connection module may enable CBs and CSs to have the ability to communicate electronically with other CSs and CBs, without the need for customized one-to-one linkages. The connection module may be implemented using customized a connection package including a server, middleware, middleware license, pre-programmed XML transactions (e.g., RosettaNet) and applications extensions (APIs) for most ERP systems. The connection module may provide easy and scalable integration between supply chain partners. Using consistent interfaces and seamless connections, the connection module may help streamline CB and CS systems and remove unnecessary complexity and redundancy from their work processes. The connection module may include predefined adapters and templates that allow for fast, efficient and easily maintainable system integration. As a result, the connection module may utilize or be implemented using various plug-and-play solutions that integrate various hardware and software package including server hardware, middleware, pre-programmed XML transaction and application extensions (APIs) for most ERP systems.

In accordance with at least one embodiment of the invention, the system and method for maintaining and utilizing component cross reference data and any exchange system including it may include or be used in conjunction with one or more user interfaces including a procurement user interface, a component manufacturer user interface, a design engineer user interface, a logistics user interface, etc.

The procurement user interface may be configured to provide DMs, or CBs, with data about their IPNs at one single site location or globally through out all the user's organization's corporate sites. This access may enable a user to identify identical product to match their need in house and potentially avoid paying twice or three times the standard cost for components in times of shortage. Prior to the invention, there were no wide IPN schemas to identify product stored under a different naming convention. The MCR may use a unique UPN to link all applicable aspects for easy access.

The procurement user interface may be configured to provide access to corporate IPNs linked to MPNs approved for purchase and further linked to other IPNs which could identify in house inventory that has not yet been committed to manufacturing.

The design engineer user interface may be configured to provide access to the ASC and IEC data so as to allow access to a set of functionally interchangeable components enhanced with percentages depicting global design engineering preferences for any given component functionality. The user interface may be configured to allow entry of an MPN and viewing of a finite set of manufacturer names and a percentage associate with each name. The percentages may represent the frequency with which design engineers globally are designing in competitive CMs' MPNs with the same component functionality as the entered MPN. A click on the CM's name may reveal that particular manufacturer's MPN for the design engineer to consider adding to a new IPN, as an ASC or IEC to be used to implement the IPN during a constrained market to keep production running.

The CM user interface may be configured to provide access to data indicating design-in success against competitive manufacturers' products for the same functional IPN through percentages depicting actual global design engineering selections. The CM user interface may be similar to the design engineer user interface in that it allows access to the percentage with which design engineers globally are designing in the various MPNs for specific component functionality. The manufacturers cannot generate this data themselves and by simply entering any one of their MPNs that are able to view their success or lack thereof in winning design slots (corresponding to DM IPNs) within global design engineering community. This data may be particularly important when new components are released and the manufacturers want to monitor the sales teams' efforts to get their components designed-in.

The logistics user interface may be configured to provide access to data, e.g., Electronic Commodity Control Numbers (ECCNs) and Harmonized Tariff Schedule (HTS), used to support import/export compliance necessary for organizations importing and exporting components. Access to this data can greatly reduce the amount of manpower necessary to avoid time delays in shipping and receiving components. The ECCN, HTS and United States Customs Description for each manufacturer's MPN may be stored in the MPR data structure. Over time, the MPR may be cross-populated for identical component functionality through the use of the MCR across manufacturers' MPNs.

It should be understood that the systems and methods designed in accordance with at least one embodiment of the invention utilize and provide controlled access to all data stored in the component market memory 420 illustrated in FIG. 4 through a plurality of security levels. Such security levels may be policed and administered using security mechanisms provided in the processor 430 based on operation instructions in the operational memory 440. In accordance with at least one embodiment of the invention, users associated with the exchange system, for example, traders on the exchange, administrators associated with exchange, analysts associated with exchange, etc., are permitted to view all CB and CS data including IPNs, ASCs and IECs. However, trading partners may be only permitted access to subsets of data to ensure confidentiality of data provided to the exchange by CBs and CSs.

Exchange system traders may access the exchange system to generate additional trades. For example, if a CS has excess inventory of a given component, the exchange trader is not limited to matching CBs with a current demand of the component. Based on data about past component transactions, the exchange system trader/broker can inquire with past CBs and CSs of that component as well as past CBs and CSs of both ASCs and IECs to identify potential components for trade.

In accordance with at least one embodiment of the invention, CBs and other interested entities can search for components using CB-specific IPNs. This flexibility allows for improved ease of use because a prospective CB does not have to be aware of the correct MPNs associated with particular IPNs.

As result of the features provided via at least one embodiment of the invention, various benefits are provided to DMs and CMs, whether they be CBs or CSs. In accordance with at least one embodiment, the exchange system allows for rationalization of all of IPNs within a single plant location or campus to be mapped to all applicable MPNs. As a result, because IPNs are linked to each other where applicable, potential CBs may avoid purchasing components that may be in their own inventory but referenced under another IPN.

Additionally, global rationalization of IPNs, including all the various plant locations and component numbering schemas for all IPNs may be provided. Further, global rationalization of all DMs' and CMs' IPNs for all plant locations and all component numbering schema may be provided. Access to such data may be limited to traders and other personnel associated with the exchange system. With this data, it is significantly easier to locate components in times of component shortages, when trying to locate obsolete or hard to find components. As a result, such data increases the potential sales possibilities when trying to move DM excess inventory positions.

In accordance with at least one embodiment of the invention, access to specific data may be provided to CMs with regard to their design-in approvals in the engineering community . A counter may be utilized by placing it on the identified number of ASCs+IECs for each MPN prior to omitting duplicates from the approved and inferred equivalent sets so that the combination of ASC+IEC set may be a limited list of unique component numbers. Next, the IPN design-in efforts for each CM in the ASC+IEC set is subtotaled. Subsequently, this subtotal is then divided by the total number of unique (AcctCode+IPN) combinations that share the same UPN as the record whose “Design Engineering % Calculation” is being computed. This data may provide an indicator of the number of design engineers at DMs and contract manufacturers that have “designed in” the various MPNs. CMs may be interested in determining how there design-in efforts are succeeding or failing to capture desired penetration levels, as compared to their competition, particularly with new products being introduced to the marketplace in the early stages of new product introduction.

Thus, in accordance with at least one embodiment of the invention CMs may be provided with a tool for gathering design-in and usage data associated with their individual MPNs. Such a tool may provide the CM with such data including percentages of penetration in a market and CM identities associated with those percentages. The result may not include the other CMs' part numbers because this data may be proprietary to exchange system. The returned results may include percentages for CMS of the ASCs and the IECs.

Additionally, design engineers at CBs may use this data to identify a list of suitable candidates to consider “designing in” to a given IPN slot and consider the ease of which the engineer might locate components if a shortage market existed. The more companies designing in a given CM's components, the more likely there will be components available should they have delivery problems. The CB faced with delivery problems might consider the more popular alternative CM to his approved CMs or might think that is what others are doing and go for a less popular CM, figuring there will be more product available.

While the present invention will hereinafter be described in connection with at least one exemplary embodiment thereof, it should be understood that it is not intended to limit the invention to that embodiment. On the contrary, it is intended to cover all alternatives, modifications and equivalents as may be included within the spirit and scope of the invention as defined by the appended claims.

What is claimed is:

1. A system for maintaining and utilizing component cross reference data, the system being included in a component exchange system, the system being configured to enable a user to access a master cross reference list of components to guide component trading decisions on the component exchange system, the system comprising:
at least one user interface configured to at least one of receive data indicating at least one internal part number and at least one manufacturer part number for a component identified as an approved substitute component and output data included in the master cross reference list of components;
a master cross reference module configured to identify at least one inferred equivalent component based on the data indicating the at least one internal part number and the at least one manufacturer part number for the component identified as the approved substitute component; and
a master cross reference data structure configured to store the identity of at least one inferred equivalent component, the at least one internal part number and the at least one manufacturer part number for the component identified as the approved substitute component,
wherein the master cross reference module is configured to determine, output or store data to the master cross reference data structure, that data indicating the identity of at least one inferred equivalent component, the at least one internal part number and the at least one manufacturer part number for the component identified as the approved substitute component in association with a universal part number.

2. The system of claim 1, wherein the data indicating the identity of the inferred equivalent component includes a manufacturer part number.

3. The system of claim 1, wherein the master cross reference module indicates in the data output or stored to the master cross reference data structure, whether a manufacturer part number associated with a universal part number is an approved substitute component or an inferred equivalent component.

4. The system of claim 3, wherein the data indicating the identity of the at least one manufacturer part number for the component identified as the approved substitute component includes data indicating an identity of a data source indicating the approved substitute component.

5. The system of claim 1, wherein data included in the master cross reference list of components is optionally output to a user based on at least one security mechanism that allows for at least two levels of security associated with parts of that data and users accessing that data.

6. The system of claim 1, further comprising:
a master parts reference module configured to analyze data received by the master cross reference module via the at least one user interface; and
a master cross reference data structure configured to store reference data relating to trading partners, that data including at least one internal part number, at least one manufacturer part number, and at least one trading partner identity,
wherein the master parts reference module is configured to compare the data received by the master cross reference module via the at least one user interface with data included in the master parts reference data structure to identify received data that is inconsistent with the reference data.

7. The system of claim 6, further comprising a component market memory that includes both the master parts reference data structure and the master cross reference data structure.

8. The system of claim 6, wherein, following a determination that received data is inconsistent with reference data, the master parts reference module, queries a source of the inconsistent data to indicate whether the inconsistent data is erroneous or new data.

9. The system of claim 1, wherein the master cross reference module is configured to perform analysis on data received from the at least one user interface via the master parts reference module and the master parts reference module does not output data that it has identified as inconsistent to the master cross reference module.

10. The system of claim 1, further comprising at least one of:
a plan module configured to cooperate with the master cross reference module to output alerts regarding a potential component delivery problem and guidance regarding at least one approved substitute component or inferred equivalent component to avoid the potential component delivery problem;
a knowledge module configured to cooperate with the master cross reference module to identify component market trends;
a design module configured to cooperate with the master cross reference module to provide improved design information to users;
an order module configured to cooperate with the master cross reference module to at least one of reduce procurement cycle time, eliminate manual component sorting and processing, create a comprehensive audit trail and improve access to competitive pricing and available component inventories.
a trade module configured to cooperate with the master cross reference module to provide guidance on how to at least one of leverage component market size to source components in time-sensitive situations, create links with component suppliers, liquidate component inventory quickly without compromising demand for currently available components, and leveraging component markets to improve margin; and
a move module configured to cooperate with the master cross reference module to monitor supply chain performance tracking and improve supply chain management.

11. The system of claim 1, further comprising a buy/sell data comparator module configured to compare trading data from a plurality of trading partners to identify compatable component buy/sell requests.

12. The system of claim 1, further comprising a request data analyzer module configured to analyze data received via the at least one interface to identify relevant data associated with a potential component trade.

13. The system of claim 1, wherein the master cross reference module is configured to determine if at least one manufacturer part number associated with a first universal part number is an inferred equivalent of at least another manufacturer part number associated with a second universal part number and, if so, to associate those manufacturer part numbers with the first universal part number.

14. The system of claim 1, wherein the master cross reference module is configured to determine, for at least one manufacturer part number, a degree of market use of a component associated with that manufacturer part number based on how many times that manufacturer part number has been identified as an approved substitute component in the data received via the at least one user interface.

15. The system of claim 1, wherein the at least one user interface includes a procurement user interface configured to provide access to at least one internal part number linked to a plurality of manufacturer part numbers approved for purchase and further linked to other internal part numbers identifying in house inventory that has not yet been committed to manufacturing.

16. The system of claim 1, wherein the at least one user interface includes a design engineer user interface configured to provide access to data stored in the master cross reference data structure including the at least one approved substitute component and the at least one inferred equivalent component in association with the universal part number.

17. The system of claim 1, wherein the at least one user interface includes a component manufacturer user interface configured to provide access to data indicating design-in success against competitive manufacturers' products for MPNs through percentages depicting design engineering selections by component buyers, the percentages being determined based on data stored in the master cross reference data structure.

18. The system of claim 1, wherein the at least one user interface includes a logistics user interface configured to provide access to logistics data associated with a component associated with the at least one manufacturer part number.

19. A method for maintaining and utilizing component cross reference data, the method being used in connection with a component exchange system, the method enabling a user to access a master cross reference list of components to guide component trading decisions on the component exchange system, the method comprising:
accessing data indicating a plurality of approved substitute components associated with a plurality of internal part numbers and a plurality of trading partner identification data;
assigning a universal part number to each unique combination of internal part number and trading partner identification;
sorting the accessed data following the assignment of the universal part numbers to group data by manufacturer part number and component manufacturer; and
identifying at least one inferred equivalent component associated with at least one approved substitute component based on transitive property analysis of the sorted data.

20. The method of claim 19, further comprising outputting or storing data indicating the identifying at least one inferred equivalent component associated with the at least one approved substitute component and an associated universal part number.
